(19) United States
(12) Patent Application Publication
(10) Pub. No.: US 2002/0006512 A1
(43) Pub. Date: Jan. 17, 2002

(54) Corrosion-resistant conductive member

(76) Inventors: Takeshi Hikata, Itami-shi (JP); Nobuyuki Okuda, Itami-shi (JP); Takashi Uemura, Itami-shi (JP); Koichi Sogabe, Itami-shi (JP); Shosaku Yamanaka, Itami-shi (JP)

Correspondence Address: FASSE PATENT ATTORNEYS, P.A., P.O. BOX 726, HAMPDEN, ME, 04444-0726, US

(21) Appl. No.: 09/897,521

(22) Filed: Jul. 2, 2001

(30) Foreign Application Priority Data
Jul. 13, 2000 (JP) 2000-212605

(51) Int. Cl. B32B 9/00

(52) U.S. Cl. 428/408; 428/457

(57) ABSTRACT

An electrode for plating of one example of a corrosion-resistant conductive member of the present invention includes a base formed of stainless steel or the like, a first conductive film of an electrochemically noble material formed on the base, and a second conductive film of an electrochemically base material formed on the first conductive film. The second conductive film is of a material containing carbon. Thus, a corrosion-resistant conductive member is provided which has good corrosion resistance and which can be inexpensively manufactured.

### BACKGROUND OF THE INVENTION

1. Field of the Invention

The present invention relates to corrosion-resistant conductive members and, more specifically to a corrosion-resistant conductive member for use as an electrode for plating.

2. Description of the Background Art

Conventionally, a noble metal such as platinum would be used as a material of an electrode for plating. However, if the electrode is to be formed solely of platinum (Pt), the electrode for plating becomes costly. Thus, conventionally, platinum provided on a base of, e.g., titanium, would be used as an electrode for plating.

If the platinum has a thickness of smaller than about 10 μm, a pin hole may be formed. The titanium is subjected to corrosion through the pin hole, whereby the useful life of the electrochemically reactive electrode is reduced. If the platinum has a thickness of 10 μm or greater to avoid such a problem, the electrode for plating becomes costly as mentioned above.

### SUMMARY OF THE INVENTION

An object of the present invention is to provide a corrosion-resistant conductive member which has good corrosion resistance and which can be inexpensively manufactured.

The corrosion-resistant conductive member of the present invention includes a base of a metal, and first and second conductive films of different materials sequentially formed on the base. The first conductive film formed closer to the base than the second conductive film is of a material which is more noble than the second conductive film, and the second conductive film includes carbon.

According to the corrosion-resistant conductive member of the present invention, since the first conductive film is of a material which is more noble than the second conductive film, the first and second conductive films can form a local cell where the first conductive film would not dissolve in a corrosion environment. Thus, dissolution of the first conductive film is prevented, whereby dissolution of the base is prevented to provide good corrosion resistance.

Because of good corrosion resistance, the first and second conductive films are allowed to have a reduced thickness. Even if platinum is used for the first conductive film, the platinum is allowed to have a small thickness of not greater than about 10 μm, so that the corrosion-resistant conductive member can be inexpensively manufactured.

In addition, the carbon contained in the second conductive film can provide a relatively low dissolution velocity and prevents formation of an insulating film such as an oxide film on the surface of the second conductive film. Thus, conductivity of the electrode for plating can be readily ensured.

In the corrosion-resistant conductive member, preferably, the first and second conductive films respectively have pin holes passing therethough, and are layered such that the pin holes of the first and second conductive films do not in communication with each other.

Thus, corrosion of the underlying base through the pin holes of the first and second conductive films is prevented, whereby good corrosion resistance can be obtained.

In the corrosion-resistant conductive member, preferably, the first and second conductive films form a local cell in a corrosion environment, whereby the second conductive film dissolves and the first conductive film produces a gas.

The formation of such a local cell prevents dissolution of the first conductive film as mentioned above, so that corrosion of the underlying base can be prevented.

In the corrosion-resistant conductive member, preferably, a plurality of composite layers each formed of the first and second conductive films are provided.

The provision of a plurality of composite layers further enhances the corrosion preventing effect.

In the corrosion-resistant conductive member, preferably, the carbon contained in the second conductive film is at least one of diamond like carbon (DLC) and amorphous carbon (a-C).

The above mentioned DLC or a-C provides a conductive hard carbon film with good corrosion resistance. Thus, the corrosion resistance can be further enhanced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional view schematically showing the structure of an electrode for plating according to one embodiment of the present invention.

FIG. 2 is a cross sectional view schematically showing the structure of a composite layer of first and second conductive films.

FIG. 3 is a cross sectional view schematically showing the first and second conductive films coating all surfaces of a base.

### DESCRIPTION OF THE PREFERRED EMBODIMENTS

Now, an embodiment of the present invention will be described with reference to the drawings.

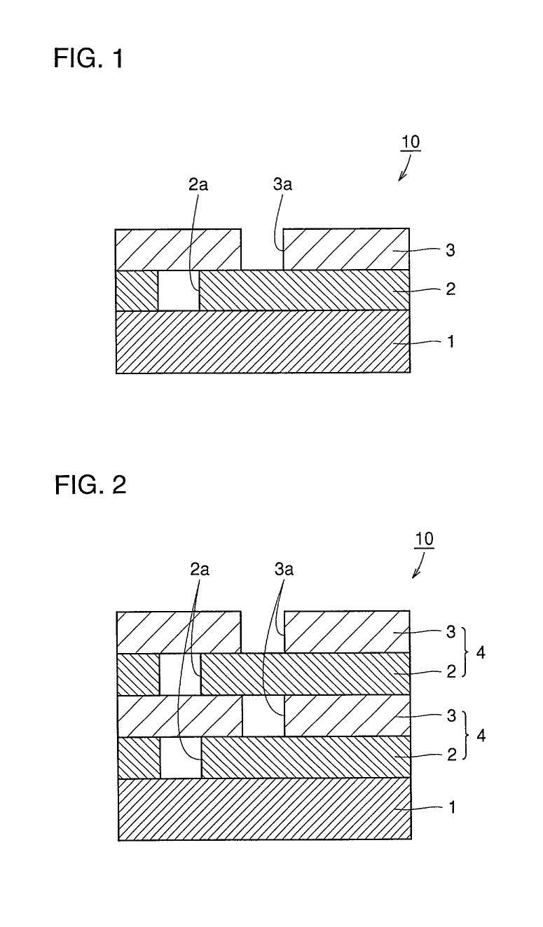

Referring to FIG. 1, an electrode for plating 10 of the present embodiment includes a base 1 formed of stainless steel or the like, a first conductive film 2 of an electrochemically noble material formed on base 1, and a second conductive film 3 of an electrochemically base material formed on first conductive film 2.

First conductive film 2 is formed of platinum or the like. Second conductive film 3 is formed of a material including carbon and is, for example, a conductive hard carbon film including a material containing at least one of DLC and a-C. Second conductive film 3 may be of a resin containing carbon.

First conductive film 2 and second conductive film 3 may have pin holes 2a and 3a, respectively, and preferably have a thickness not greater than 10 μm.

Preferably, first conductive film 2 and second conductive film 3 are formed such that pin hole 2a of first conductive film 2 and pin hole 3a of second conductive film 3 are not in communication with each other.

First conductive film 2 and second conductive film 3 form a local cell in a corrosion environment, so that second conductive film 3 dissolves and first conductive film 2 produces a gas.

According to the present embodiment, first conductive film 2 is formed of a material which is more noble than second conductive film 3, so that first conductive film 2 and second conductive film 3 can form a local cell where first conductive film 2 would not dissolve in a corrosion environment. Thus, dissolution of first conductive film 2 can be prevented, whereby dissolution of base 1 is prevented to provide good corrosion resistance.

Because of good corrosion resistance, first conductive film 2 and second conductive films 3 are allowed to have a small thickness. Thus, even if a noble metal such as platinum is used for first conductive film 2, the thickness thereof may be smaller than about 10 μm. As a result, the consumption of the noble metal such as platinum can be reduced, whereby electrode for plating 10 can be inexpensively manufactured.

The carbon contained in second conductive film 3 can provide a relatively low dissolution velocity and prevents formation of an insulating film such as an oxide film on the surface of second conductive film 3, so that conductivity of electrode for plating 10 can be readily ensured.

Since pin holes 2a and 3a, respectively of first conductive film 2 and second conductive film 3, are not in communication with each other, corrosion of underlying base 1 through pin holes 2a and 3a may be prevented. This leads to enhanced corrosion resistance.

Since second conductive film 3 contains at least one of DLC and a-C, a conductive hard carbon film with good corrosion resistance can be obtained as second conductive film 3. Thus, corrosion resistance can be further enhanced.

It is noted that electrode for plating 10 may be formed of a plurality of composite layers 4 each having first conductive film 2 and second conductive film 3 as shown in FIG. 2. The plurality of composite layers 4 can further enhance the corrosion preventing effect.

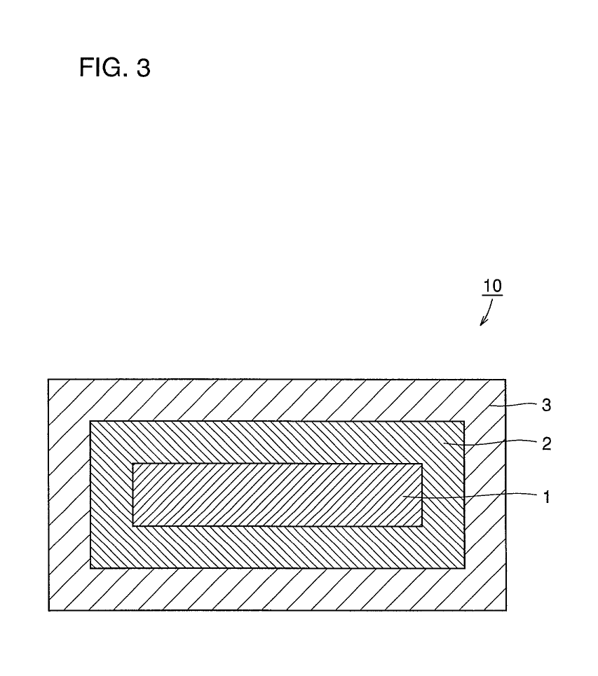

First conductive film 2 and second conductive film 3 of electrode for plating 10 may coat all surfaces of base 1 as shown in FIG. 3. Thus, the corrosion preventing effect of base 1 can be further enhanced.

Electrode for plating 10 of the present embodiment is used, for example, as an anode for gold plating or silver plating. Examples of plating baths range from an alkaline cyanic bath, alkalescent bath or neutral bath mainly containing a phosphoric acid based material, acid bath mainly containing an organic acid, to non-cyanic bath.

Although the electrode for plating has been described as one example of the corrosion-resistant conductive member in the present embodiment, the corrosion-resistant conductive member is not limited to the electrode for plating. Rather, the corrosion-resistant conductive member can find various applications other than the electrode for plating where corrosion resistance and conductivity are required.

Although stainless steel is used for base 1 by way of example in the above, any material including metal or alloy may be used for base 1.

Although platinum is used for first conductive film 2 in the above, any conductive film formed of a material which is electrochemically more noble than the second conductive film may be used.

Although DLC or a-C is used for second conductive film 2, any conductive film which is electrochemically base than the first conductive film and formed of a material containing carbon may be used.

Although base 1 and first conductive film 2 are shown in FIG. 1 as being in direct contact with each other, they do not necessarily have to be in direct contact, and any intervening layer may be provided between base 1 and first conductive film 2.

Although first conductive film 2 and second conductive film 2 are shown in FIG. 1 as being in direct contact with each other, they do not necessarily have to be in direct contact and another conductive film, which is more base than first conductive film 2 and more noble than second conductive film 3, may be provided between first conductive film 2 and second conductive film 3.

Although two composite layers 4 are provided in FIG. 2, the number of composite layers 4 does not necessarily have to be two, and three or more composite layers 4 may be provided.

In FIGS. 1 and 2, pin holes 2a and 3a are formed respectively in first conductive film 2 and second conductive film 3. However, it is more preferable that the structure is free from pin holes 2a and 3a, if reduction in thickness of first conductive film 2 and second conductive film 3 does not result in formation of pin holes 2a and 3a.

Now, an experimental result of the present invention will be described.

Platinum was deposited on the base of stainless steel SUS304 by arc ion plating to have a thickness of about 0.5 μm, and a conductive diamond like carbon (DLC) film was formed thereon to have a thickness of about 0.5 μm. The conductive DLC film had a pin hole of about 1-5 μm. With use of thus manufactured electrode material, a corrosion current experiment was carried out in H₂SO₄ with reference to a carbon cloth.

As a result, the corrosion current flowed in the dissolving direction of the DLC film and, after the experiment, the DLC had a thickness of about 0.4 μm, which is about 0.1 μm smaller than before the experiment. Production of a hydrogen gas was found from the underlying platinum layer. Corrosion was hardly found in SUS 304.

As a comparative example, copper (Cu) was deposited on a base of stainless steel SUS 304 by arc ion plating to have a thickness of 0.5 μm, and a conductive DLC film was further formed thereon to have a thickness of about 0.5 μm. A pin hole of about 1-5 μm was found in the conductive DLC film. With use of thus manufactured electrode material, a corrosion current experiment was carried out in H₂SO₄ with reference to a carbon cloth.

As a result, a corrosion current flowed in the dissolution direction of the underlying copper film, and production of a hydrogen gas was found from the upper DLC film. In addition, corrosion was found in SUS 304.

The above experiments show that corrosion of the base can be prevented if a more noble material is used for a conductive film which is closer to the base when forming a plurality of conductive films on the base.

Further, when three composite layers each formed of conductive DLC and platinum were provided, the corrosion experiment result showed, after fifty days, no corrosion in SUS 304, whereas corrosion was partly found in SUS 304 in the case of a single layer.

From the above, it is found that the greater number of composite layers each formed of a noble conductive film and base conductive film provides a stronger corrosion preventing effect.

As described above, according to the corrosion-resistant conductive member of the present invention, the first conductive film is formed of a material which is more noble that the second conductive film, so that the first and second conductive films can form a local cell where the first conductive film does not dissolve in a corrosion environment. Thus, dissolution of the first conductive film is prevented and dissolution of the base is prevented to provide good corrosion resistance.

Because of good corrosion resistance, the first and second conductive films are allowed to have a smaller thickness. Thus, even if platinum is used for the first conductive film, the thickness of the platinum may be less than about 10 μm, so that the corrosion-resistant conductive film can be inexpensively manufactured.

In addition, the carbon contained in the second conductive film provides a relatively low dissolution velocity and prevents formation of an insulating film such as an oxide film on the surface of the second conductive film, so that conductivity of the electrode for plating can be readily ensured.

Accordingly, the corrosion-resistant conductive member of the present invention is suitable for use as an electrode for plating.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A corrosion-resistant conductive member, comprising a base containing a metal, and first and second conductive films of different materials sequentially formed on said base, wherein said first conductive film formed closer to said base than said second conductive film is formed of a more noble material than said second conductive film, and said second conductive film contains carbon.

2. The corrosion-resistant conductive member according to claim 1, wherein said first conductive film and said second conductive film respectively have pin holes passing therethrough, and said first and second conductive films are layered in such a way to avoid communication of the pin holes.

3. The corrosion-resistant conductive member according to claim 1, wherein said first conductive film and said second conductive film form a local cell in a corrosion environment, so that said second conductive film dissolves and said first conductive film produces a gas.

4. The corrosion-resistant conductive member according to claim 1, wherein a plurality of composite layers each formed of said first conductive film and said second conductive film are provided.

5. The corrosion-resistant conductive member according to claim 1, wherein the carbon contained in said second conductive film is at least one of diamond like carbon (DLC) and amorphous carbon.
